(19) United States
(12) Patent Application Publication
(10) Pub. No.: US 2020/0230986 A1
(43) Pub. Date: Jul. 23, 2020

(54) IMAGE FORMING APPARATUS

(71) Applicants: Munekazu HIRATA, Tokyo (JP); Tomoya FUJII, Kanagawa (JP); Masatoshi ISHIDA, Kanagawa (JP); Kunihiko NISHIOKA, Kanagawa (JP); Takayuki ANDOH, Kanagawa (JP); Masashi OTA, Kanagawa (JP); Yohei OSANAI, Kanagawa (JP); Satoshi NARAI, Kanagawa (JP)

(72) Inventors: Munekazu HIRATA, Tokyo (JP); Tomoya FUJII, Kanagawa (JP); Masatoshi ISHIDA, Kanagawa (JP); Kunihiko NISHIOKA, Kanagawa (JP); Takayuki ANDOH, Kanagawa (JP); Masashi OTA, Kanagawa (JP); Yohei OSANAI, Kanagawa (JP); Satoshi NARAI, Kanagawa (JP)

(73) Assignee: Ricoh Company, Ltd.

(21) Appl. No.: 16/745,385

(22) Filed: Jan. 17, 2020

(30) Foreign Application Priority Data
Jan. 23, 2019 (JP) 2019-009042

(51) Int. Cl. B41J 29/02; B41J 3/36

(52) U.S. Cl. CPC B41J 29/02; H04M 1/7253; B41J 3/36

(57) ABSTRACT

An image forming apparatus includes an apparatus body, a cover, a first positioning member, and a second positioning member. The apparatus body includes a mounted portion. The cover is detachably mounted on the apparatus body. The cover includes a mounting portion configured to be mounted on the mounted portion of the apparatus body. The first positioning member is configured to position the cover at a first target position in a first direction with respect to the apparatus body. The second positioning member is configured to position the cover at a second target position in a second direction orthogonal to the first direction with respect to the apparatus body, before the mounting portion is mounted on the mounted portion after the cover is positioned at the first target position by the first positioning member.

### CROSS-REFERENCE TO RELATED APPLICATION

This patent application is based on and claims priority pursuant to 35 U.S.C. § 119(a) to Japanese Patent Application No. 2019-009042, filed on Jan. 23, 2019, in the Japan Patent Office, the entire disclosure of which is hereby incorporated by reference herein.

### BACKGROUND

### Technical Field

The present disclosure relates to an image forming apparatus.

### Related Art

There has been known an image forming apparatus in which a cover having a mounting portion to be mounted on a mounted portion of an apparatus body is detachable from the apparatus body.

For example, a handheld mobile printer (image forming apparatus) is known that has a cap (cover). The cap has a portion (mounting portion) that covers a bottom surface of an apparatus body including a recording head (mounting portion). In the handheld mobile printer, one end of a substantially L-shaped rotating arm is rotatably supported around a shaft on a side surface of the apparatus body and the cap is held at the other end of the rotating arm. The rotating arm is rotated to attach and detach the portion of the cap to and from the bottom surface of the apparatus body.

### SUMMARY

In an aspect of the present disclosure, an image forming apparatus that includes an apparatus body, a cover, a first positioning member, and a second positioning member. The apparatus body includes a mounted portion. The cover is detachably mounted on the apparatus body. The cover includes a mounting portion configured to be mounted on the mounted portion of the apparatus body. The first positioning member is configured to position the cover at a first target position in a first direction with respect to the apparatus body. The second positioning member is configured to position the cover at a second target position in a second direction orthogonal to the first direction with respect to the apparatus body, before the mounting portion is mounted on the mounted portion after the cover is positioned at the first target position by the first positioning member.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is an exterior perspective view illustrating a handheld printer as viewed from above obliquely according to Embodiment 1;

FIG. 2 is an exterior perspective view of a printer body of the handheld printer illustrated in FIG. 1, in a state in which a cover is removed from the printer body;

FIG. 3 is an exterior perspective view of the printer body in a state in which a spacer is detached, as viewed obliquely from below;

FIG. 4 is a perspective view of the printer body in a state in which a printed image is being formed on a recording medium;

FIG. 5 is a perspective view illustrating a state where an inkjet head (ink cartridge) is removed from the printer body;

FIG. 6 is a block diagram illustrating a part of an electric circuit of the printer body;

FIG. 7 is a partial cross-sectional view of a lower unit of the printer body, with the left roller unit attached thereto;

FIG. 8 is a right side view of the printer body being a roller contact state in which the printer body without the spacer is moved for scanning with rollers rolling on a recording medium or a table on which the recording medium is placed;

FIG. 9 is a right side view of the printer body being a roller contactless state in which the printer body to which the spacer is attached is moved for scanning with rollers kept contactless with the recording medium or the table on which the recording medium is placed;

FIG. 10 is an exterior perspective view of the printer body in a state in which the spacer is attached thereto, as viewed obliquely from below;

FIG. 11 is a schematic view illustrating the printer body being moved along a curved track in a roller contactless state;

FIG. 12 is a perspective view in which a left wall of the cover is removed to illustrate an interior of the cover;

FIG. 13 is a bottom view of the cover;

FIG. 14A is a top view of the cover in a state in which only the spacer is placed on the bottom board of the cover and the printer body is not mounted thereon; FIG. 14B is a cross-sectional view taken along line A-A in FIG. 14A;

FIG. 15A is a top view of the cover in a state in which only the spacer is placed on the bottom board of the cover and the printer body is not mounted thereon; FIG. 15B is a cross-sectional view taken along line A′-A′ in FIG. 15A;

FIG. 16 is a bottom view of the printer body illustrating a contact location that an edge of a cap portion of the cover contacts when the cover is correctly mounted on the printer body;

FIG. 17A is a perspective view illustrating a state of the printer body and the cover in the middle of attachment movement in a case where the cover is correctly attached to the printer body; FIG. 17B is a cross-sectional view of the printer body and the cover taken along a Y-Z plane in the state of FIG. 17A;

FIG. 18 is a cross-sectional view of the printer body and the cover along the Y-Z plane when the cover is correctly mounted on the printer body;

FIGS. 19A and 19B are perspective views of the printer body and the cover in a state in which improper mounting is performed with the printer body and the cover being inclined with respect to each other;

FIG. 20A is a perspective view of the printer body and the cover in a state in which the printer body is rotatable around an axis extending in an X direction with respect to the cover, with a contact point of a guide projection against the printer body being as a fulcrum; FIG. 20B is a cross-sectional view of the printer body and the cover taken along a Y-Z plane in the state of FIG. 20A;

FIG. 21 is a side view of the printer body with a variation of a guide groove; and

FIG. 22 is a side view of the printer body with another variation of a guide projection and the guide groove.

The accompanying drawings are intended to depict embodiments of the present disclosure and should not be interpreted to limit the scope thereof The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, embodiments will be described with reference to the drawings. For clarity of the description, omission and simplification are made appropriately in description and drawings hereinafter. In the drawings, constituent elements having the same configurations or functions and the corresponding parts are denoted by the same reference signs, and the description thereof is omitted.

Descriptions are given below of a handheld mobile inkjet printer (hereinafter simply referred to as “handheld printer”) that is a mobile image forming apparatus, according to an embodiment of the present disclosure. First, a basic configuration of a printer body of the handheld printer according to the present embodiment is described.

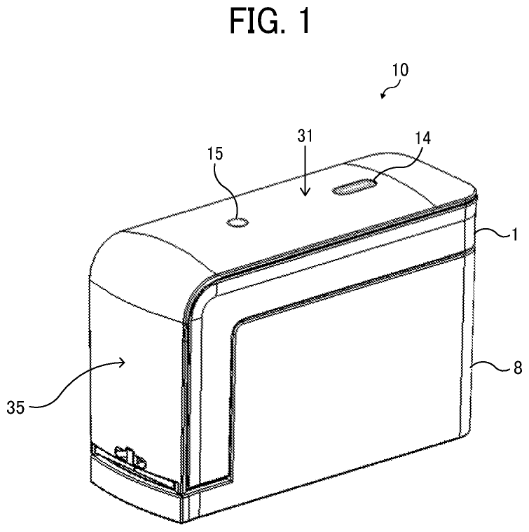

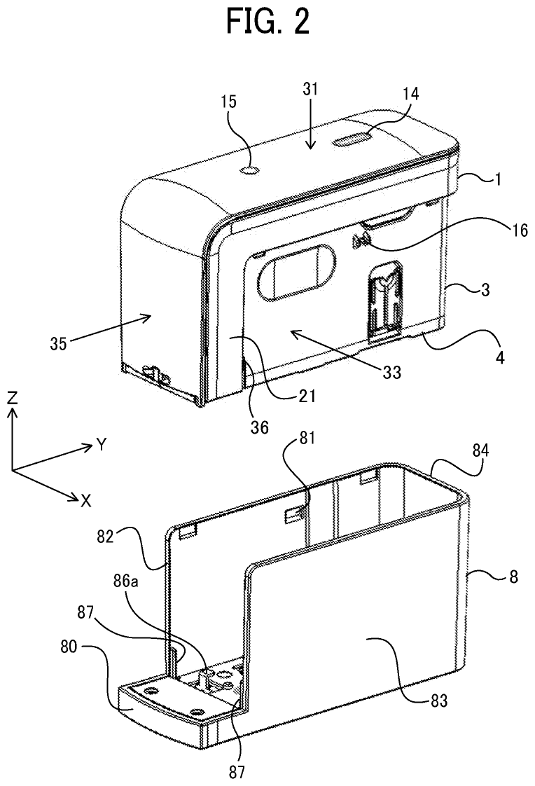

FIG. 1 is a perspective view illustrating an exterior of a handheld printer 10 according to the present embodiment, as viewed from obliquely above. FIG. 2 is an exterior perspective view of the printer body 1 in which a cover 8 is removed from the printer body 1. The printer body 1 is an apparatus body of the handheld printer 10.

The handheld printer 10 according to the present embodiment includes the printer body 1, a spacer 4 serving as an attachment to be removably attached to the printer body 1, and a cover 8. The cover 8 is mounted on the printer body 1 with the spacer 4 housed in the cover 8. The cover 8 is made of resin such as acrylonitrile butadiene styrene (ABS) resin, and recesses 81 are formed on the inner wall surface of the cover 8. When the cover 8 is attached to the printer body 1, two projections 16 (one of the two is illustrated in FIG. 2) as holding portions provided on the printer body 1 are respectively hooked to two recesses 81 (one of the two is illustrated in FIG. 2) as held portions provided on the cover 8 by snap-fit. With such a configuration, the state in which the cover 8 is attached to the printer body 1 is held. When removing the cover 8 from the printer body 1, the user pulls the printer body 1 out of the cover 8 so that the projections 16 caught by the snap-fit are removed from the recesses 81 and the user can remove the cover 8 from the printer body 1.

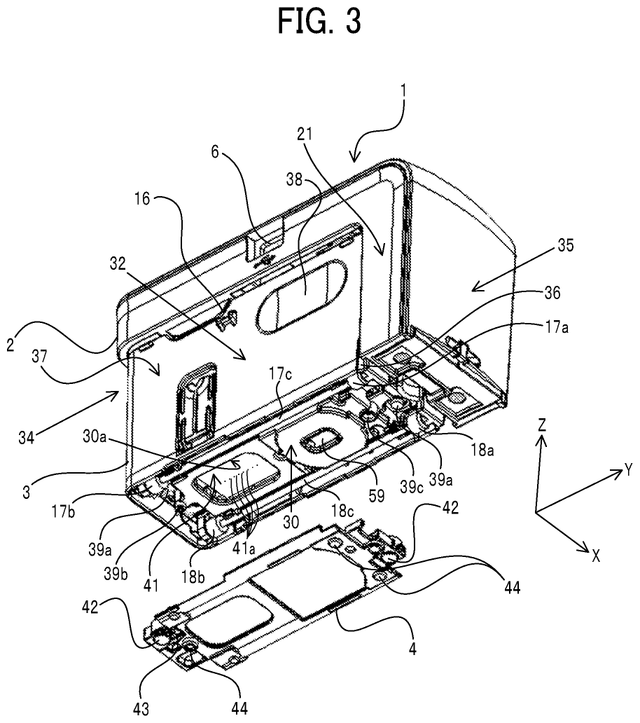

FIG. 3 is an exterior perspective view of the printer body 1 and the spacer 4 removed from the printer body 1, as viewed obliquely from below. The printer body 1 illustrated in FIG. 3 includes an upper unit 2 and a lower unit 3. The printer body 1 as a whole is shaped like a rectangular parallelepiped. In a scanning direction, that is, a printing direction indicated by arrow X in FIG. 1 (X direction), the printer body 1 has such a length that a user can grasp the printer body 1 with a palm.

The housing of the printer body 1 includes a recording side 30 on which a recording portion 41 (as an image forming device) of an inkjet head (described later) is disposed opposed to a recording medium such as a paper sheet, an upper side 31 opposite the recording side 30, a left side 32 extending in a direction indicated by arrow Y (hereinafter also referred to as “scanning orthogonal direction” or “Y direction”), orthogonal to a scanning direction (indicated by arrow X, hereinafter also referred to as X direction). The housing further includes, for example, a right side 33 extending in the direction orthogonal to the scanning direction (X direction), a rear side 34 extending in the scanning direction, and a front side 35 extending in the scanning direction. The printer body 1 is usually used in such a posture that the recording side 30 is faced vertically down and the upper side 31, which is opposite the recording side 30, is faced vertically up.

A print button 14 and a power button 15 are disposed on the upper side 31. The left side 32 of the upper unit 2 includes a universal serial bus (USB) connection port 6. The USB connection port 6 is a port for connecting a USB cable. The printer body 1 is provided with a rechargeable battery mounted therein. The rechargeable battery can be charged when electric power is supplied thereto from an external power supply via the USB cable connected to the USB connection port 6.

On the front side 35 of the lower unit 3, a wide portion 21 of the upper unit 2 wider than a narrow portion 37 of the lower unit 3 is positioned. On the left side 32 and the right side 33 of the narrow portion 37 of the lower unit 3, finger-grip portions 38 are formed at the positions where the user applies the fingers (usually the thumb and one of the middle finger and the ring finger) of the hand, respectively, while gripping and using the printer body 1. To move the printer body 1 on a surface of the recording medium in the scanning direction (X direction) for image formation, the user holds the printer body 1 as follows. The user positions the wide portion 21 closer to the wrist side and sandwiches the lower unit 3 with the fingers applied to the finger-grip portions 38 on the left side 32 and the right side 33, respectively.

The wide portion 21 is made wider than the narrow portion 37 in the scanning orthogonal direction so that the outer wall surface of the wide portion 21 and the outer wall surface of the cover 8 are on a substantially identical plane when the cover 8 is attached to the printer body 1, as illustrated in FIG. 1.

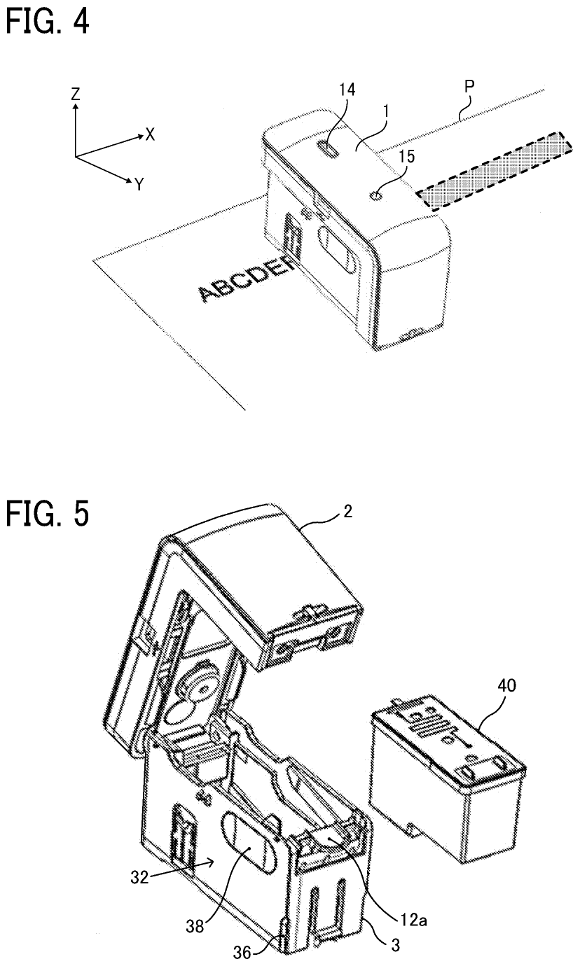

The user can switch on and off the power of the printer body 1 by holding down the power button 15. When the power is turned on, a control board provided in the upper unit 2 of the printer body 1 can acquire image data by wireless communication with a smartphone or the like. After the user places the printer body 1 on the surface of a recording medium P with the recording side 30 facing the surface of the recording medium P, the user presses the print button 14 once and moves the printer body 1 in the scanning direction (X direction) as illustrated in FIG. 4, thus forming an image on the recording medium P. The printer body 1 can form an image on the surface of the recording medium in both of forward movement and backward movement in the scanning direction (manual scanning) when the user moves the printer body 1 back and forth.

The recording medium P is not limited to paper, such as paper sheets, but includes any other image formation targets, for example, overhead projector (OHP) sheets, cloth, cardboards, packaging containers, glass, and substrates.

FIG. 5 is a perspective view illustrating a state where an inkjet head 40 (ink cartridge) is removed from the printer body 1. As illustrated in FIG. 5, the printer body 1 of the present embodiment is supported by the lower unit 3 such that the upper unit 2 opens and closes with respect to the lower unit 3. Inside the lower unit 3, the ink-tank-integrated inkjet head 40 (ink cartridge) integral with a recording portion 41 and an ink tank is detachably attached. At this time, the recording portion 41 to discharge ink droplets is faced down in the vertical direction. The inkjet head 40 discharges ink droplets from the recording portion 41 to record an image on a recording medium. When the user pulls an attaching-and-detaching operated portion 12a of a cartridge attaching-and-detaching mechanism to the front side, the inkjet head 40 is lifted up and turns into a removable state.

As illustrated in FIG. 3, the recording side 30 of the printer body 1 includes an opening 30a to expose the recording portion 41 of the inkjet head 40 mounted in the lower unit 3 to the outside. The recording portion 41 of the inkjet head 40 includes a plurality of discharge nozzles 41a (e.g., ports) and is capable of discharging ink droplets separately from the respective discharge nozzles 41a as piezoelectric elements are driven.

As a driving source to discharge ink, the inkjet head 40 employs, for example, an electromechanical transducer element (piezoelectric actuators) including a lamination-type piezoelectric element or a thin-film-type piezoelectric element; an electrothermal transducer element, such as a heat element; or an electrostatic actuator including a diaphragm and opposed electrodes.

The “ink (liquid)” discharged from the discharge nozzles 41a of the recording portion 41 is not particularly limited as long as the liquid has a viscosity and a surface tension that enable discharge from the discharge nozzles 41a. However, it is preferable that the viscosity is 30 mPa·s or less under ordinary temperature and pressure or by heating or cooling. Specifically, the term “ink (liquid)” represents, for example, a solution, a suspension, or an emulsion including a solvent, such as water or organic solvent, a colorant, such as a dye or a pigment, a polymerizable compound, a resin, a functional material, such as a surfactant, a biocompatible material, such as deoxyribonucleic acid (DNA), amino acid, protein, or calcium, or an edible material, such as a natural colorant. Such a solution, a suspension, or an emulsion can be used for, e.g., inkjet ink, surface treatment solution, a liquid for forming components of electronic element or light-emitting element or a resist pattern of electronic circuit, or a material solution for three-dimensional fabrication.

Inside the outer edge of the recording side 30, a position sensor 59 as a detector to detect the position of the printer body 1 on the recording medium, a first left roller 17a, a second left roller 17b, a first right roller 18a, and a second right roller 18b that are rotatable are disposed.

When the user moves the printer body 1 in the scanning direction, the four rollers contacting the surface of the recording medium P rotate like tires. Owing to such rollers, the user can move forward or backward the printer body 1 straight in the scanning direction. At this time, only the four rollers of the printer body 1 are in contact with the surface of the recording medium and keep a predetermined distance between the recording side 30 and the surface of the recording medium. Therefore, a constant distance can be maintained between the recording portion 41 of the inkjet head 40 and the surface of the recording medium, thus forming a desired high-quality image.

The position detection sensor 59 is a sensor to detect the distance to the surface of the recording medium, the surface state (for example, asperities) of the recording medium, and the distance by which the printer body 1 has traveled. The position detection sensor 59 is similar to a sensor used for, for example, an optical mouse (a pointing device) of a personal computer. The position detection sensor 59 irradiates, with light, a place (the recording medium) where the printer body 1 is placed and reads the state of the place as a “pattern”. The position detection sensor 59 sequentially detects how the “pattern” moves relative to the movement of the position detection sensor 59, to calculate the amount of movement.

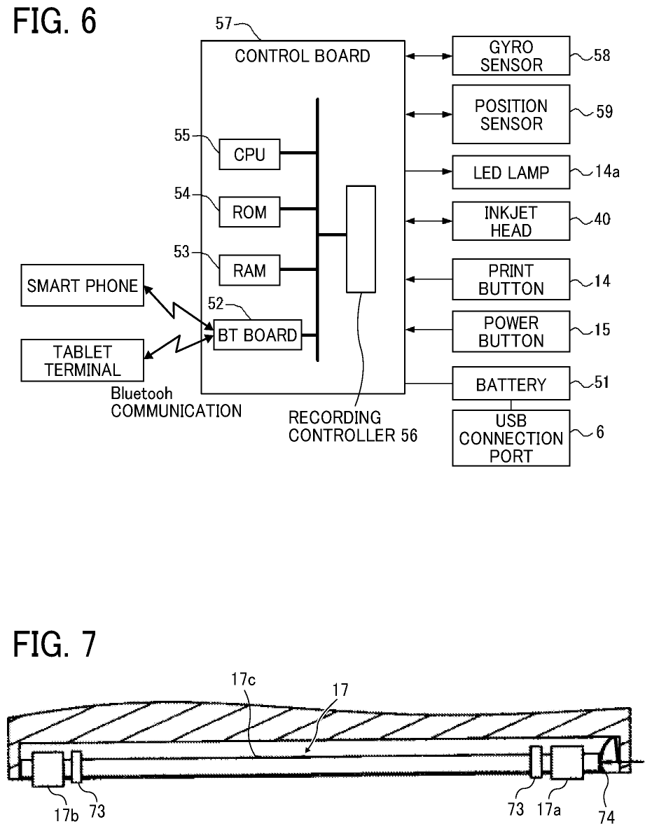

FIG. 6 is a block diagram illustrating a portion of an electric circuit of the printer body 1. A control board 57 includes a central processing unit (CPU) 55 that performs various arithmetic processing and program execution, a Bluetooth (registered trademark, hereinafter “BT”) board 52 for short-range wireless communication, a random access memory (RAM) 53 that temporarily stores data, a read-only memory (ROM) 54, and a recording controller 56. The control board 57 is secured at a position on the back side of the USB connection port 6 in a hollow space of the upper unit 2.

The BT board 52 performs data communication by short-range wireless communication (Bluetooth communication) with an external device, such as a smartphone or a tablet terminal. The ROM 54 stores, for example, firmware for hardware control of the printer body 1 and drive waveform data of the inkjet head 40. The recording controller 56 executes data processing for driving the inkjet head 40 and generates drive waveforms.

The control board 57 is electrically connected to a gyro sensor 58, the position detection sensor 59, an LED lamp 14a, the inkjet head 40, the print button 14, the power button 15, the battery 51, and the like.

The gyro sensor 58 detects the tilt and rotation angle of the printer body 1 and transmits the detection result to the control board 57. The LED lamp 14a is disposed inside an exterior cover, made of a light transmissive material, of the print button 14 and makes the print button 14 luminous.

When the power button 15 is pressed to turn on the power of the printer body 1, power is supplied to each module. The CPU 55 initiates startup according to the program stored in the ROM 54 and loads the program and each data in the RAM 53. When data of an image to be formed is received from an external device by short-range wireless communication, the recording controller 56 generates a drive waveform corresponding to the image data. Then, the discharge of ink from the inkjet head 40 is controlled to form an image corresponding to the position on the surface of the recording medium detected by the position detection sensor 59.

During acquisition of image data via short-range wireless communication from an external device, the control board 57 causes the LED lamp 14a to blink so that the light transmissive print button 14, which transmits light, becomes luminous and blinks. Then, after the acquisition of the image data completes, the control board 57 causes the LED lamp 14a to keep emitting light so that the print button 14 continuously emits light. Seeing such light emission, the user knows the completion of the acquisition of the image data. Then, the user places the printer body 1 on the recording medium and presses the print button 14.

Meanwhile, as the control board 57 starts blinking of the LED lamp 14a, the control board 57 waits for pressing of the print button 14. When the print button 14 is pressed, the control board 57 causes the LED lamp 14a to blink so that the print button 14 becomes luminous and blinks. Seeing such blinking, the user starts moving the printer body 1 in the scanning direction (manual scanning).

Finishing moving (manual scanning) of the printer body 1, the user presses the print button 14 again. With such an operation, the control board 57 turns off the LED lamp 14a and stops lighting of the print button 14. Or, there may be a case where the user does not press the print button 14 and picks up the printer body 1 from the recording medium and places the printer body 1 such as on a table or places the printer body 1 onto the cover 8. In this case, at the timing the user picks up the printer body 1 from the recording medium, the position detection sensor 59 no longer detects the position. At the timing when the position detection sensor 59 no longer detects the position, the control board 57 turns off the LED lamp 14a and stops lighting of the print button 14.

It is not necessary to keep pushing the print button 14 while the user moves (manual scanning) the printer body 1. Once the print button 14 is pushed and released before the moving of the printer body 1, the image forming operation based on the detection result by the position detection sensor 59 is continued until the end of the image formation, or the print button 14 is pushed again, or the end of the position detection by the position detection sensor 59.

In the printer body 1 according to the present embodiment, the rollers 17a and 17b of the left roller unit 17 and the rollers 18a and 18b of the right roller unit 18 are disposed at positions deviating from the recording portion 41 in the orthogonal direction (indicated by arrow Y) to the scanning direction. In such an arrangement, when the printer body 1 is moved, the rollers 17a, 17b, 18a, and 18b are inhibited from contacting an image portion immediately after formed. Therefore, the image can be protected from being disturbed by the rollers 17a, 17b, 18a, and 18b contacting the image portion.

FIG. 7 is a partial cross-sectional view of the lower unit 3 of the printer body 1, with the left roller unit 17 attached thereto. A pressing flat spring 74 is attached to a wall of the lower unit 3. For example, the pressing flat spring 74 is fixed thereto. The pressing flat spring 74 presses one longitudinal end of the shaft 17c of the left roller unit 17 toward the other end side in the axial direction so that the other longitudinal end of the shaft 17c is pressed against an inner wall of the casing of the lower unit 3.

In this manner, the shaft 17c of the left roller unit 17 is pressed in the axial direction by the pressing flat spring 74 to suppress the backlash of the first roller 17a and the second roller 17b in the axial direction (eliminate space allowing backlash). As a result, image distortion due to the backlash can be reduced.

Although the description above concerns pressing the shaft 17c of the left roller unit 17 in the axial direction with the pressing flat spring 74, the shaft 18c of the right roller unit 18 is similarly pressed in the axial direction by a pressing flat spring. Instead of attaching the pressing flat springs to the casing, the pressing flat springs can be attached to the end portions of the shafts 17c and 18c of the roller units 17 and 18. The pressing flat spring can be fixed thereto. Such a manner eliminates a process of assembling the pressurizing plate springs to the casing to enable reduction in assembling cost.

Here, in the configuration provided with the rollers 17a, 17b, 18a, and 18b like the printer body 1 according to the present embodiment, as described above, when the user moves the printer body 1 in the scanning direction (manual scanning), the straight traveling performance is secured. However, the rollers 17a, 17b, 18a, and 18b inhibit smooth traveling when the printer body 1 is moved along a curved track, thus inhibit smooth manual scanning.

In addition, when recording on the second line is performed after recording on the first line, a line feed operation is required to move the printer body 1 in the scanning orthogonal direction with the recording side 30 kept facing the surface of the recording medium so that position detection by the position sensor 59 is not disabled. Also in the line feed operation, the rollers 17a, 17b, 18a, and 18b of the printer body 1 may inhibit the movement in the scanning orthogonal direction and become a hindrance to a smooth line feed operation.

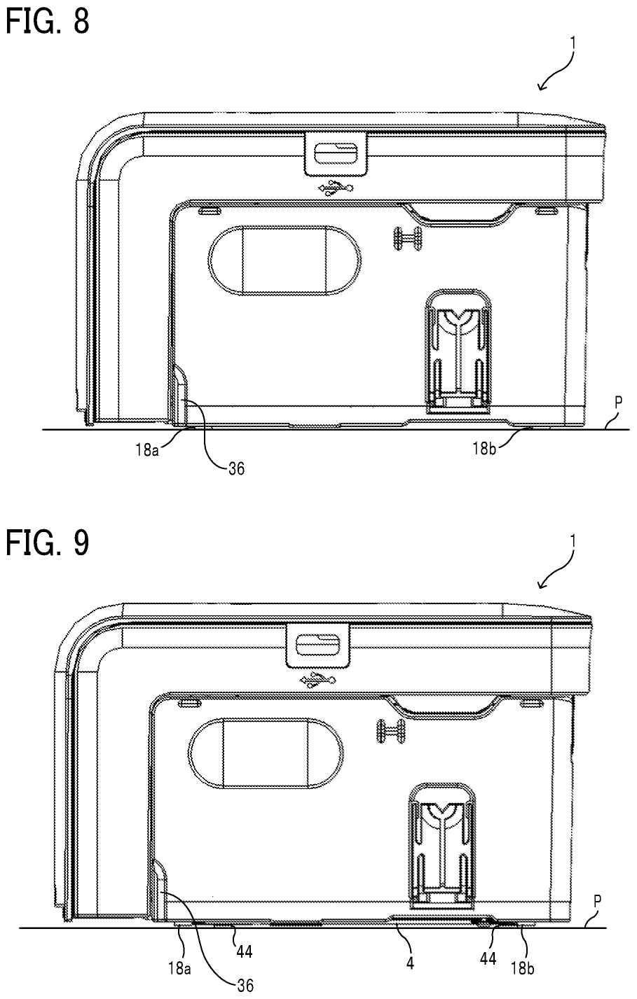

Therefore, the handheld printer 10 of the present embodiment is provided with the spacer 4 attachable to and removable from the recording side 30 of the printer body 1, and the usage form of the handheld printer 10 can be switched by attaching and removing the spacer 4. Specifically, the usage form can be switched between: a roller contact state in which scanning is performed while the rollers 17a, 17b, 18a, and 18b are in contact with the surface of the table on which the recording medium P is placed or the surface of the recording medium P (see FIG. 8); and a roller contactless state in which the rollers 17a, 17b, 18a, and 18b are not in contact with the surface of the table on which the recording medium P is placed or the surface of the recording medium P (see FIG. 9).

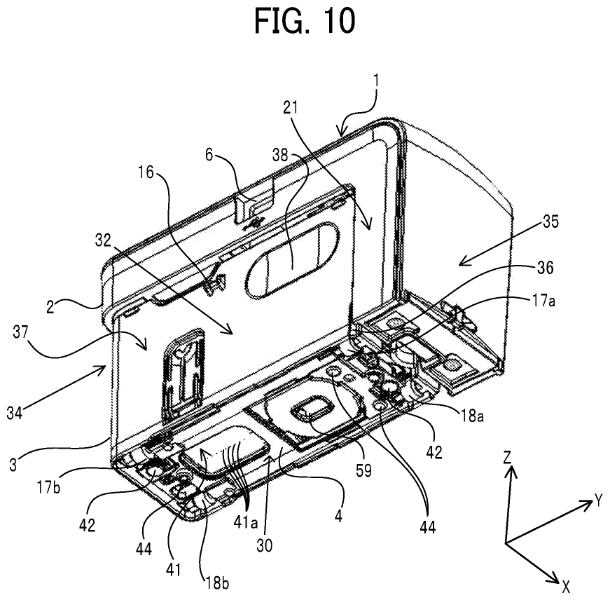

FIG. 10 is an exterior perspective view of the printer body 1 in a state in which the spacer 4 is attached thereto, as viewed obliquely from below. When the spacer 4 is removed from the printer body 1, the handheld printer 10 can be used in the roller contact state in which the printer body 1 is moved for scanning with the rollers 17a, 17b, 18a, and 18b of the printer body 1 in contact with and rolling on the surface of the recording medium P as illustrated in FIG. 8. As a result, owing to straight traveling performance of the rollers 17a, 17b, 18a, and 18b, the user can easily move the printer body 1 straight along the scanning direction and can form an appropriate image. On the other hand, when the spacer 4 is attached to the recording side 30 of the printer body 1, the handheld printer 10 can be used in the roller contactless state in which the printer body 1 is moved for scanning with the rollers 17a, 17b, 18a, and 18b of the printer body 1 contactless with the surface of the recording medium P and the like as illustrated in FIG. 9.

The spacer 4 is attached to and detached from the recording side 30 of the lower unit 3 with magnets. Specifically, the spacer 4 includes magnets 42, and screw heads 39a of metal screws that are two magnetic bodies are exposed to the recording side 30. The magnets 42 are disposed to oppose the screw heads 39a when the spacer 4 is attached to the recording side 30 of the printer body 1. In the present embodiment, the magnetic body provided on the spacer 4 is described as an example of a fastening member such as a metal screw, but may be a frame member such as a metal frame of the spacer 4. Such a frame member is usually made of metal in order to secure rigidity and can be used as a magnetic body.

Further, as illustrated in FIG. 3, in order to align the recording side 30 of the lower unit 3 with the spacer 4, an alignment projection 39b and an alignment hole 39c are formed on the recording side 30. On the spacer 4, an alignment hole 43 where the alignment projection 39b fits and an alignment projection which fits in the alignment hole 39c are formed at respective corresponding positions. When the spacer 4 is aligned with the recording side 30 such that the alignment projection and the alignment hole fit in and around the alignment hole and alignment projection on the other side, the magnets 42 on the spacer 4 face the screw heads 39a of the recording side 30. Then, as illustrated in FIG. 10, the spacer 4 is mounted and held onto the recording side 30 by the magnetic force of the magnets 42.

The body of the spacer 4 is made of resin such as ABS resin. Three projections 44 to support the printer body 1 are provided on a recording medium opposing side) of the spacer 4, which is opposite the side facing the recording side 30 when the spacer 4 is attached to the printer body 1. In the state in which the spacer 4 is mounted on the recording side 30 of the printer body 1, as illustrated in FIG. 9, tips of the projections 44 are farther from the recording side 30 than the rollers 17a, 17b, 18a, and 18b in the direction in which the recording side 30 faces the recording medium P. Therefore, when the printer body 1 to which the spacer 4 is attached is placed on the recording medium P, the tips of the projections 44 contact the recording side 30 to float the rollers 17a, 17b, 18a, and 18b from the surface of the recording medium P. Then, the handheld printer 10 is in the roller contactless state.

To use the handheld printer 10 in the roller contactless state, the user holds the printer body 1 and places the printer body 1 on the recording medium P so that the recording side 30 to which the spacer 4 is attached opposes the surface of the recording medium P. At that time, the printer body 1 is supported at three points by the projections 44 of the spacer 4 so that the rollers 17a, 17b, 18a, and 18b float from the surface of the recording medium P. Then, the user can move the printer body 1 (manual scanning) so that the three projections 44 slide on the surface of the recording medium P, to form an image on the recording medium P.

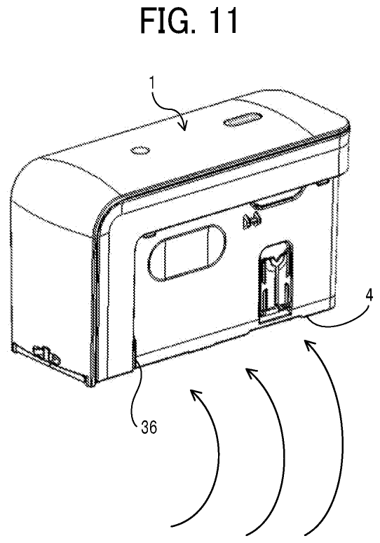

FIG. 11 is a perspective view illustrating the printer body 1 being moved along a curved track in the roller contactless state. In the roller contactless state, since the rollers 17a, 17b, 18a, and 18b float from the surface of the recording medium P, an operation of moving the printer body 1 (manual operation) in a direction different from the scanning direction (X direction) is not disturbed by the rollers 17a, 17b, 18a, and 18b. Therefore, the curved traveling performance of the printer body 1 is improved compared to the roller contact state. As a result, the printer body 1 can be easily moved along the curved track.

In addition, in a case where, after recording of the first line in the scanning direction, recording of the second line is performed at a position different in the scanning orthogonal direction, the rollers 17a, 17b, 18a, and 18b do not disturb the line feed operation to move the printer body 1 in the scanning orthogonal direction with the recording side 30 kept facing the recording medium. Therefore, the operability of the line feed operation is improved compared to the roller contact state. In the roller contactless state, since the straight traveling performance by the rollers 17a, 17b, 18a, and 18b is not feasible, the user needs to move the printer body 1 straight in the scanning direction without assistance from the rollers 17a, 17b, 18a, and 18b.

According to the present embodiment, each of the three projections 44 of the spacer 4 is disposed out of the range of the recording portion 41 (where the plurality of discharge nozzles 41a are located) of the inkjet head 40 in the direction (Y direction) orthogonal to the scanning direction. Thus, the image can be protected from being disturbed by the projections 44 rubbing against the image portion immediately after formed during image formation in the roller contactless state.

Next, descriptions are given below of the cover 8 of the handheld printer 10 according to the present embodiment. The cover 8 according to the present embodiment is mountable to the printer body 1 in a state in which the spacer 4 mounted to the printer body 1 is accommodated in the cover 8. As illustrated in FIG. 2, the cover 8 according to the present embodiment includes a bottom board 80 on which the printer body 1 is placed and three walls, that is, a left wall 82, a right wall 83, and a rear wall 84 extending, in the Z direction in the drawings, from the top surface of the bottom board 80. In a state in which the printer body 1 is placed on the bottom board 80, the three walls, that is, the left wall 82, the right wall 83, and the rear wall 84 respectively face the left side 32, the right side 33, and the rear side 34 of the narrow portion 37 in the lower unit 3 of the printer body 1.

In the present embodiment, for example, the cover 8 is attached to the printer body 1 in the following method. The printer body 1 is inserted, from the upper side (Z direction) in the drawing, into the cover 8 placed on the table as illustrated in FIG. 2 so that the narrow portion 37 of the lower unit 3 of the printer body 1 fits in the space surrounded by the left wall 82, the right wall 83, and the rear wall 84. Then, the two projections 16 of the printer body 1 are respectively hooked, by snap-fit, on the two recesses 81 on the inner faces of the left wall 82 and the right wall 83 of the cover 8. As a result, the cover 8 is kept attached to the printer body 1.

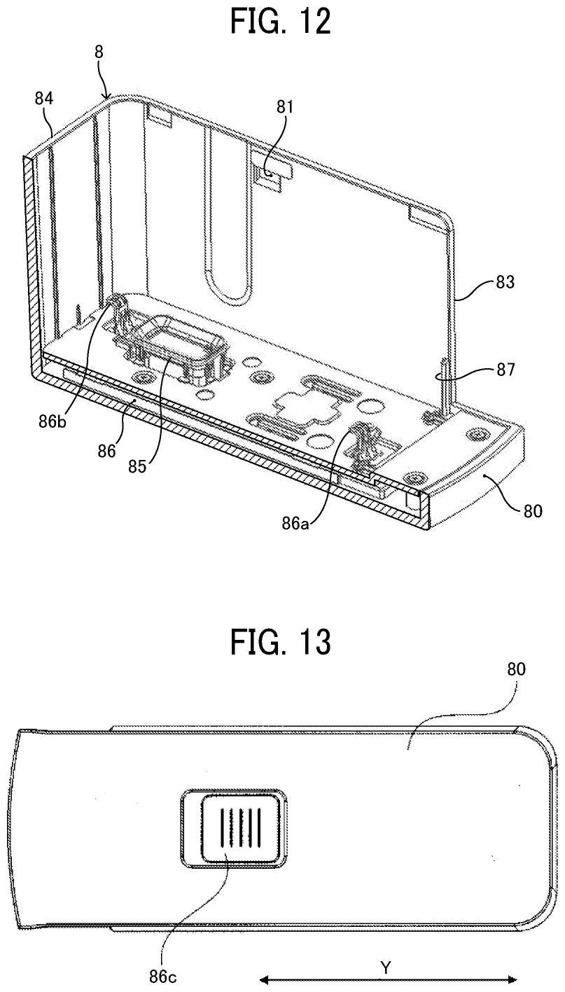

FIG. 12 is a perspective view in which the left wall 82 is removed to illustrate an interior of the cover 8. The cover 8 according to the present embodiment includes a cap portion 85 as an image-forming-device protector to protect the recording portion (the plurality of discharge nozzles 41a) of the inkjet head 40. The cap portion 85 as a mounting portion is mounted on the recording portion 41 as a mounted portion. In a state in which the cover 8 is attached to the printer body 1, the cap portion 85 is mounted in tight contact with the recording portion of the inkjet head 40 exposed on the recording side 30 of the printer body 1, to cover the plurality of discharge nozzles 41a in the recording portion 41. With this configuration, in a state in which the cover 8 is attached to the printer body 1, the discharge nozzles 41a of the printer body 1 are sealed in the cap portion 85. Thus, the discharge nozzles 41a are protected, and moisture therein is retained.

In the present embodiment, the handheld printer 10 includes an attachment switching device to switch a hold state of the spacer 4 between an attachment state in which the spacer 4 is attachable to the printer body 1 and a detachment state in which the spacer 4 is detachable from the printer body 1, when the cover 8 is detached from the printer body 1. The attachment switching device according to the present embodiment is provided in the cover 8 to switch a cover holding state in which the spacer 4 is held by the cover 8 and a body holding state in which the spacer 4 can be held by the printer body 1 (in other words, a non-holding state in which the spacer 4 is not held by the cover 8).

In the present embodiment, the slide lock member 86 is configured to slide on the bottom board 80 along the direction (Y direction) orthogonal to the scanning direction. Specifically, as illustrated in FIG. 13, on the lower face of the bottom board 80 of the cover 8, a slide operation portion 86c secured to the slide lock member 86 is exposed. As the user slides the slide operation portion 86c along the Y direction in FIG. 13, the slide lock member 86 slides in conjunction with sliding of the slide operation portion 86c.

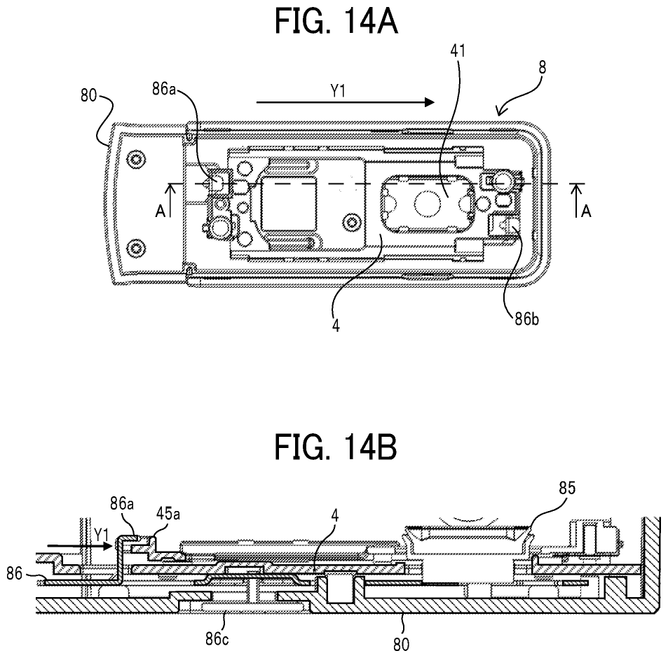

FIG. 14A is a top view illustrating only the spacer 4 is placed on the bottom face part 80 of the cover 8 with the printer body 1 not installed. FIG. 14B is a cross-sectional view illustrating cross section A-A in FIG. 14A. FIGS. 14A and 14B illustrate the cover holding state in which the spacer 4 is held by the cover 8. As the user slides the slide operation portion 86c in the direction indicated by arrow Y1 in FIGS. 14A and 14B, the slide lock member 86 slides in the direction indicated by arrow Y1 in conjunction with sliding of the slide operation portion 86c. The slide lock member 86 includes lock portions 86a and 86b to engage the locked portions 45a and 45b of the spacer 4.

As the slide lock member 86 slides in the direction indicated by arrow Y1 in the drawing, as illustrated in FIG. 14B, an end of the lock portion 86a on the slide lock member 86 is positioned above the locked portion 45a of the spacer 4. Similarly, an end of the lock portion 86b is positioned above the locked portion 45b. Here, the spacer 4 is attached to the printer body 1 with the magnetic force. With this configuration, when the user pulls out the printer body 1 from the cover 8 in the Z direction in order to remove the printer body 1 from the cover 8, the locked portions 45a and 45b of the spacer 4 are caught on the ends of the lock portions 86a and 86b of the slide lock member 86 of the cover 8 and prevented from following the printer body 1 being pulled. This is a lock state (engaged state) in which the slide lock member 86 locks the spacer 4.

As a result, when the printer body 1 is pulled out of the cover 8, the spacer 4 is held on the cover 8 side. Therefore, to use the handheld printer 10 with the rollers (in the roller contact state), as illustrated in FIGS. 14A and 14B, the user can obtain, with the sliding operation in the direction indicated by arrow Y1, the printer body 1 from which the spacer 4 is removed when the printer body 1 is pulled out. Then, the user can perform image formation in that state.

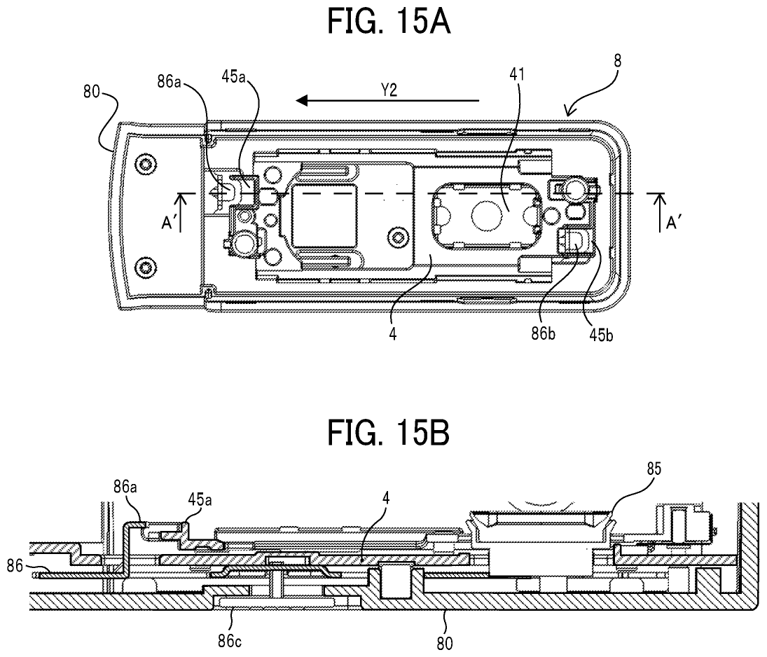

FIG. 15A is a top view of the cover 8 in a state in which only the spacer 4 is placed on the bottom board 80 of the cover 8 and the printer body 1 is not mounted thereon. FIG. 15B is a cross-sectional view taken along line A′-A′ in FIG. 15A. FIGS. 15A and 15B illustrate the body holding state in which the spacer 4 can be held by the printer body 1 (in other words, a non-holding state in which the spacer 4 is not held by the cover 8). When the user slides the slide operation portion 86c in the direction indicated by arrow Y2 in FIGS. 15A and 15B, the slide lock member 86 slides in the direction indicated by arrow Y2 in the drawing in conjunction with sliding of the slide operation portion 86c. As the slide lock member 86 slides in the direction indicated by arrow Y2 in the drawing, as illustrated in FIG. 15B, the end of the lock portion 86a on the slide lock member 86 is withdrawn from above the locked portion 45a of the spacer 4. The lock portion 86b is withdrawn similarly.

Thus, the locked portions 45a and 45b of the spacer 4 are released from the ends of the lock portions 86a and 86b of the slide lock member 86 of the cover 8. That is, the spacer 4 is in an unlocked state (disengaged state) in which the slide lock member 86 releases the spacer 4. Accordingly, as the user pulls out the printer body 1 from the cover 8 in the Z direction in order to remove the cover 8 from the printer body 1, the spacer 4 is pulled out from the cover 8 in a state held by the printer body 1 by the magnetic force. As a result, when the printer body 1 is pulled out from the cover 8, the spacer 4 is kept attached to the recording side 30 of the printer body 1 by the magnetic force.

Therefore, when the user uses the handheld printer 10 without the rollers (roller contactless state), as illustrated in FIGS. 15A and 15B, the user can obtain, with the sliding operation in the direction indicated by arrow Y2, the printer body 1 with the spacer 4 attached thereto when the printer body 1 is pulled out. Then, the user can perform image formation in that state.

The cover 8 includes a magnetic body at a position opposite the magnet of the spacer 4 so that the spacer 4 is held by the cover 8 by the magnetic force. Such a configuration can make the spacer 4 less easily removable from the cover 8 even when the user slides the slide operation portion 86c in the direction indicated by arrow Y2 in FIG. 15A, to change the locked state of the spacer 4 illustrated in FIGS. 14A and 14B to the unlocked state illustrated in FIGS. 15A and 15B, in the state in which the printer body 1 is not mounted on the cover 8. Such a configuration can prevent the spacer 4 from falling from the cover 8 when the side of the cover 8 from which the printer body 1 is inserted is turned down. Further, in a state in which the spacer 4 and the cover 8 are attached to the printer body 1 in the unlocked state illustrated in FIGS. 15A and 15B, the magnetic force between the printer body 1 and the spacer 4 is stronger than the magnetic force between the cover 8 and the spacer 4. Accordingly, when the cover 8 is removed from the printer body 1 in the state illustrated in FIGS. 15A and 15B, the spacer 4 is kept attached to the printer body 1 and removed from the cover 8.

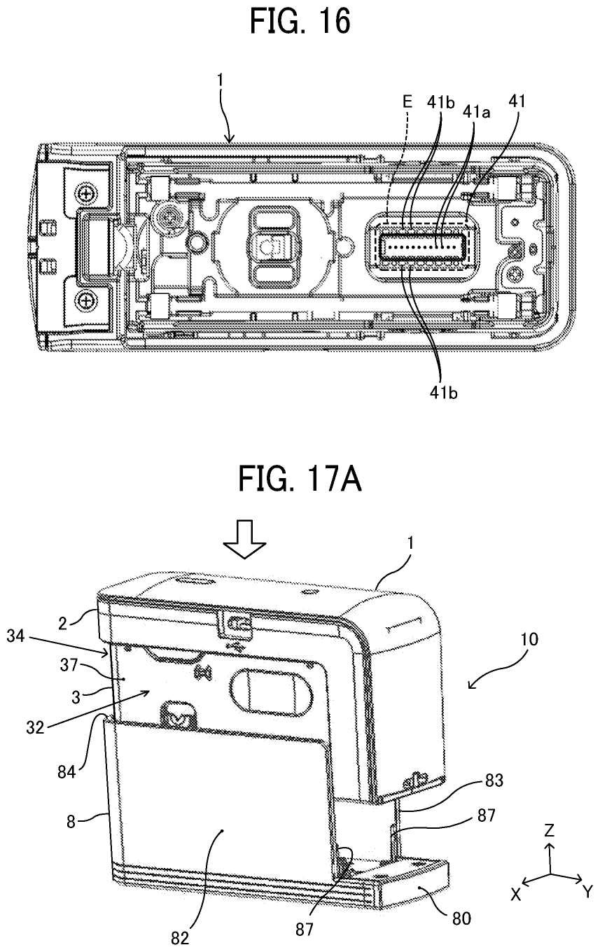

FIG. 16 is a bottom view of the printer body 1 illustrating a contact location E that the edge of the cap portion 85 of the cover 8 contacts when the cover 8 is correctly mounted on the printer body 1. In the case of the present embodiment, when the cover 8 is correctly mounted on the printer body 1, the edge of the cap portion 85 of the cover 8 contacts the contact location E indicated by a broken line in FIG. 16 on the recording portion 41 of the inkjet head 40 in the printer body 1. Since this contact location E is located so as to surround the plurality of discharge nozzles 41a and mounting components 41b on the recording portion 41, the edge of the cap portion 85 does not contact the plurality of discharge nozzles 41a and the mounting components 41b.

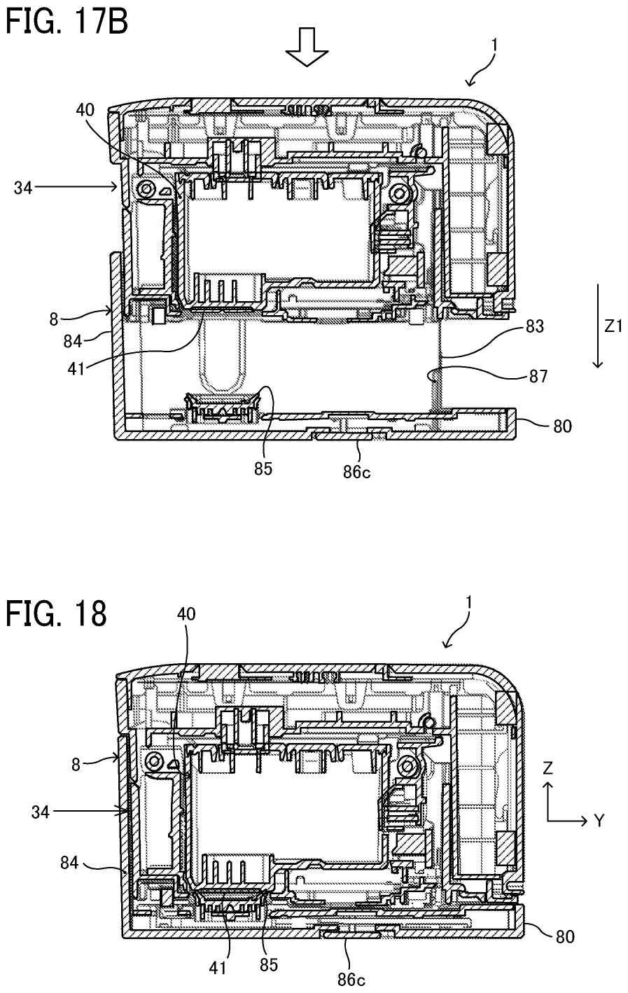

FIG. 17A is a perspective view of the handheld printer in a state in the middle of mounting movement in a case where the cover 8 is correctly mounted on the printer body 1. FIG. 17B is a cross-sectional view of the handheld printer taken along a Y-Z plane in the state of FIG. 17A. If the cover 8 is not correctly mounted on the printer body 1, he edge of the cap portion 85 of the cover 8 might collide with the discharge nozzles 41a or the mounting components 41b on the recording portion 41 of the inkjet head 40 in the printer body 1, thus causing damage or failure of the recording portion 41 or the cap portion 85.

To correctly mount the cover 8 on the printer body 1, first, a position in the X direction (first direction) and a position in the Y direction (second direction) of the cover 8 with respect to the printer body 1 are set to target positions at which the edge of the cap portion 85 of the cover 8 is opposed to the regular contact location E above the recording portion 41 of the inkjet head 40. After the setting, as illustrated in FIGS. 17A and 17B, the printer body 1 and the cover 8 are relatively moved (for mounting movement) along a Z direction such that the cap portion 85 of the cover 8 moves and contacts straight along the Z direction with respect to the recording portion 41 of the inkjet head 40 in the printer body 1. In such a mounting operation, as illustrated in FIG. 18, the edge of the cap portion 85 of the cover 8 comes into contact with the regular contact location E on the recording portion 41 of the inkjet head 40. In other words, the edge of the cap portion 85 does not contact the discharge nozzles 41a and the mounting components 41b.

However, if it is possible to perform such an improper mounting movement that the printer body 1 and the cover 8 are relatively moved along the Z direction without the position of the cover 8 with respect to the printer body 1 being set to the target position described above and the cap portion 85 directly contacts the recording portion 41, the edge of the cap portion 85 of the cover 8 might collide with the discharge nozzles 41a or the mounting components 41b on the recording portion 41.

Therefore, in the present embodiment, means is provided for preventing improper mounting movement such that the edge of the cap portion 85 of the cover 8 collides with the discharge nozzles 41a or the mounting components 41b on the recording portion 41. In order to prevent improper mounting movement (in order for the cover 8 to be correctly mounted on the printer body 1), the cap portion 85 is mounted from the Z direction while being positioned at the respective target positions in two directions (the X direction and the Y direction) perpendicular to the Z direction that is a normal mounting direction of the cap portion 85 with respect to the recording portion 41.

Hence, in the present embodiment, the handheld printer includes a first positioning member to position the cover 8 at a first target position in the X direction (first direction) with respect to the printer body 1 during the mounting movement, and a second positioning member to position the cover 8 at a second target position in the Y direction (second direction) with respect to the printer body 1 before the cap portion 85 is mounted on the recording portion 41 after being positioned at the target positions.

In the present embodiment, the first positioning member includes both sides of the printer body 1 in the X direction (that is, the left side 32 and the right side 33 of the narrow portion 37 in the lower unit 3 of the printer body 1) and the left wall 82 and the right wall 83. The left side 32 and the right side 33 extend from the bottom board 80 as a cover base on which the cap portion 85 of the cover 8 is disposed. The left wall 82 and the right wall 83 are cover side walls to contact the left side 32 and the right side 33, respectively, to position the cover 8 at the first target position.

When mounting the cover 8 to the printer body 1, the user first enters the narrow portion 37 of the printer body 1 between the left wall 82 and the right wall 83 of the cover 8. Accordingly, the left side 32 and the right side 33 of the narrow portion 37 of the printer body 1 contact the inner wall surfaces of the left wall 82 and the right wall 83 of the cover 8 and thus the movement of in the X direction of the left side 32 and the right side 33 is restricted. As a result, the position of the cover 8 in the X direction with respect to the printer body 1 is positioned at the target position (first target position) in the X direction.

Here, in the present embodiment, the cover 8 includes the rear wall 84 as a cover one-side wall. The rear wall 84 extends from the bottom board 80 on which the cap portion 85 is provided, and contacts the rear side 34 of the printer body 1 in the Y direction to restrict movement in the contact direction. Therefore, after the user enters the narrow portion 37 of the printer body 1 between the left wall 82 and the right wall 83 of the cover 8 to position the cover 8 in the X direction, the user contacts the rear side 34 of the printer body 1 with the inner wall surface of the rear wall 84 of the cover 8, thus restricting movement of the printer body 1 to the rear side.

If the restricted state of the movement of the printer body 1 to the rear side is thus maintained, the position of the cover 8 in the Y direction with respect to the printer body 1 is positioned at the target position (second target position) in the Y direction. Therefore, when the printer body 1 and the cover 8 are relatively moved in the Z direction (for mounting movement) such that the cap portion 85 of the cover 8 contacts the recording portion 41 of the printer body 1 straight along the Z direction while maintaining the restricted state, the edge of the cap portion 85 of the cover 8 contacts the regular contact location E on the recording portion 41, thus allowing proper mounting.

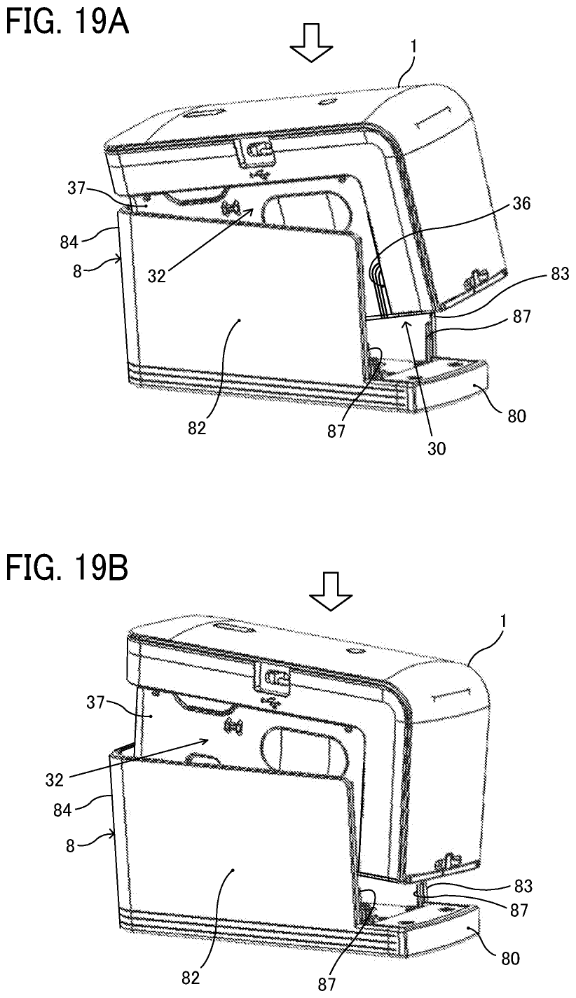

However, by merely restricting the movement of the printer body 1 to the rear side as described above, the state in which the position of the cover 8 in the Y direction with respect to the printer body 1 is positioned at the target position may not be maintained, thus hampering proper mounting. As such an improper mounting movement, for example, as illustrated in FIGS. 19A and 19B, the printer body 1 and the cover 8 may be relatively moved along the Z direction in a state in which the printer body 1 and the cover 8 are inclined relative to each other (rotated around an axis extending in the X direction), and the cap portion 85 may contact the recording portion 41. In such a case, for example, the edge of the cap portion 85 of the cover 8 might collide with the discharge nozzles 41a or the mounting components 41b on the recording portion 41 and cause damage or failure of the recording portion 41 or the cap portion 85.

Hence, the second positioning member of the present embodiment includes guide projections 87 of the cover 8 and guide grooves 36 of the printer body 1. The guide grooves 36 guide the guide projections 87 along the normal mounting direction (a direction indicated by arrow Z1 in FIG. 17B) of the cap portion 85 to the recording portion 41 while restricting movement of the guide projections 87 in the Y direction.

The guide groove 36 of the printer body 1 extend along the Z direction and has a groove width (Y direction length) that is substantially the same as the Y direction length of the guide projection 87 of the cover 8 (length enough to form a slight clearance that allows the guide projection 87 to slide in the guide groove 36). Thus, entering of the guide projection 87 of the cover 8 into the guide groove 36 of the printer body 1 causes both side parts in the Y direction of the guide projection 87 to come into contact with both inner side surfaces in the Y direction of the guide groove 36, and the movement in the Y direction is restricted. As a result, the position of the cover 8 in the Y direction with respect to the printer body 1 is positioned at the target position in the Y direction (second target position).

Here, the guide projections 87 of the present embodiment are provided at lower inner wall portions of the left wall 82 and the right wall 83 of the cover 8. Thus, at the initial stage when the narrow portion 37 of the printer body 1 enters between the left wall 82 and the right wall 83 of the cover 8 to position the cover 8 in the X direction, the guide projections 87 are located below the printer body 1 and do not enter the guide grooves 36 of the printer body 1. Therefore, in the present embodiment, after the narrow portion 37 of the printer body 1 enters between the left wall 82 and the right wall 83 of the cover 8 to position the cover 8 in the X direction, the guide projections 87 enter the guide grooves 36 to position the cover 8 in the Y direction.

As described above, stepwise positioning in the X direction and the Y direction facilitates the user operation as compared with a case where the positioning in both he X direction and the Y direction is simultaneously performed. Such a configuration can restrain a user operation of performing improper mounting movement in which the cover 8 is not correctly mounted toward the target position of the printer body 1. Thus, the cover 8 can be correctly mounted on the printer body 1 while preventing the edge of the cap portion 85 of the cover 8 and the like from colliding with the discharge nozzles 41a or the mounting components 41b on the recording portion 41.

In particular, in the present embodiment, the guide projection 87 of the cover 8 has an elongated shape extending along the Z direction. Therefore, if the elongated direction of the guide projection 87 of the cover 8 does not match the extending direction of the guide groove 36 of the printer body 1, the guide projection 87 does not enter the guide groove 36, thus hampering the positioning in the Y direction. That is, in the present embodiment, the guide projection 87 cannot enter the guide groove 36 when the Y-direction position of the cover 8 with respect to the printer body 1 is not at the target position. In such a state, the guide projection 87 contacts the recording side 30 of the printer body 1, thus restricting the movement of the printer body 1 in the Z direction with respect to the cover 8.

Therefore, in the present embodiment, unless the guide projections 87 enter the guide grooves 36 to position the cover 8 in the Y direction after the narrow portion 37 of the printer body 1 enters between the left wall 82 and the right wall 83 of the cover 8 to position the cover 8 in the X direction, the guide projections 87 contact the recording side 30 of the printer body 1, thus preventing the cover 8 from being mounted on the printer body 1. Such a configuration prevents the edge of the cap portion 85 of the cover 8 from colliding with the discharge nozzles 41a or the mounted components 41b on the recording portion 41 due to improper mounting movement.

Further, in the present embodiment, the guide projections 87 constituting part of the second positioning member are disposed at positions deviated to the side (front side) of the cover 8 opposite the rear wall 84 in the Y direction. Assume that the guide projections 87 are disposed at positions deviated toward the rear wall 84 (rear side) of the cover 8. In such a configuration, when the mounting movement in the Z direction is performed in a state in which the printer body 1 is slightly shifted to the front side with respect to the cover 8 (a state in which the guide projections 87 are located at positions closer to the rear side than the printer body 1), the guide projections 87 would not contact the recording side 30 of the printer body 1 and the recording side 30 of the printer body 1 would reach the bottom board 80 of the cover 8. Accordingly, components (such as the recording portion 41 and the position sensor 59) on the recording side 30 would contact members on the bottom board 80 and be easily damaged or broken. The arrangement of the present embodiment can restrain such a failure.

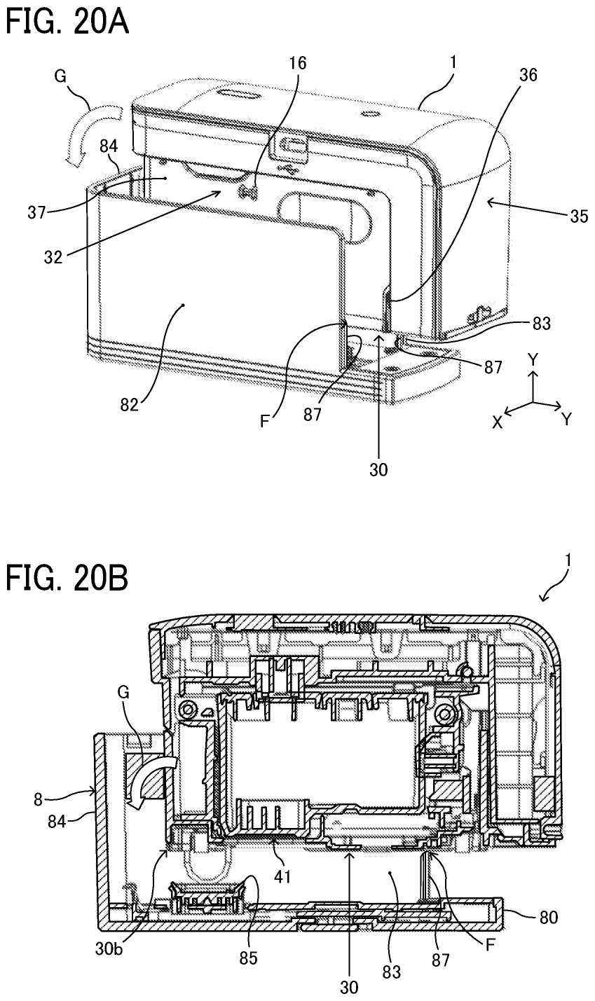

In the present embodiment, when the guide projections 87 contact the recording side 30 of the printer body 1 and restrict the movement of the printer body 1 in the Z direction with respect to the cover 8, as illustrated in FIGS. 20A and 20B, the printer body 1 is rotatable around the axis extending in the X direction with respect to the cover 8 as indicated by arrow G in FIGS. 20A and 20B. Such rotation may cause a collision between the recording side 30 of the printer body 1 and the bottom board 80 of the cover 8. In such a case, for example, a failure may occur such that a rear side edge 30b of the recording side 30 of the printer body 1 contacts and damage the cap portion 85 of the cover 8.

Therefore, in the present embodiment, a rotation stopper is provided to restrict such rotation. For example, when the above-described rotation occurs, the projections 16 on the left side 32 and the right side 33 of the printer body 1 contact upper end portions (end portions on the opposite side of the bottom board 80) of the left wall 82 and the right wall 83 of the cover 8 to restrict the above-described rotation. Accordingly, even if the above-described rotation occurs when the guide projections 87 contact the recording side 30 of the printer body to restrict the movement of the printer body 1 with respect to the cover 8 in the Z direction, collision of the recording side 30 of the printer body 1 with the bottom board 80 of cover 8 is avoided.

In particular, in the present embodiment, the projections 16 constituting at least part of the rotation stopper are the holding portions to hold the recesses 81 as the held portions, which are provided on the left wall 82 and the right wall 83 of the cover 8, when the cover 8 is mounted to the printer body 1. Using the holding portions in the rotation stopper can simplify the configuration.

The guide groove 36 of the present embodiment has a uniform groove width substantially equal to the length of the guide projection 87 in the Y direction. Therefore, the guide projection 87 cannot enter the guide groove 36 until the Y-direction position of the guide projection 87 matches the Y-direction position of the guide groove 36. Accordingly, the user might not smoothly enter the guide projections 87 into the guide grooves 36, thus decreasing user convenience.

Therefore, preferably, the groove width (length in the Y direction) of an entrance of the guide groove 36 into which a leading end of the guide projection 87 enters when the cover 8 is mounted to the printer body 1 is greater than the width (length in the Y direction) of the leading end of the guide projection 87. In addition, the width of a part of the guide projection 87 that has entered the guide groove 36 when the cover 8 is completely mounted on the printer body 1 is substantially the same as the groove width of a part of the guide groove 36 facing the part of the guide projection 87.

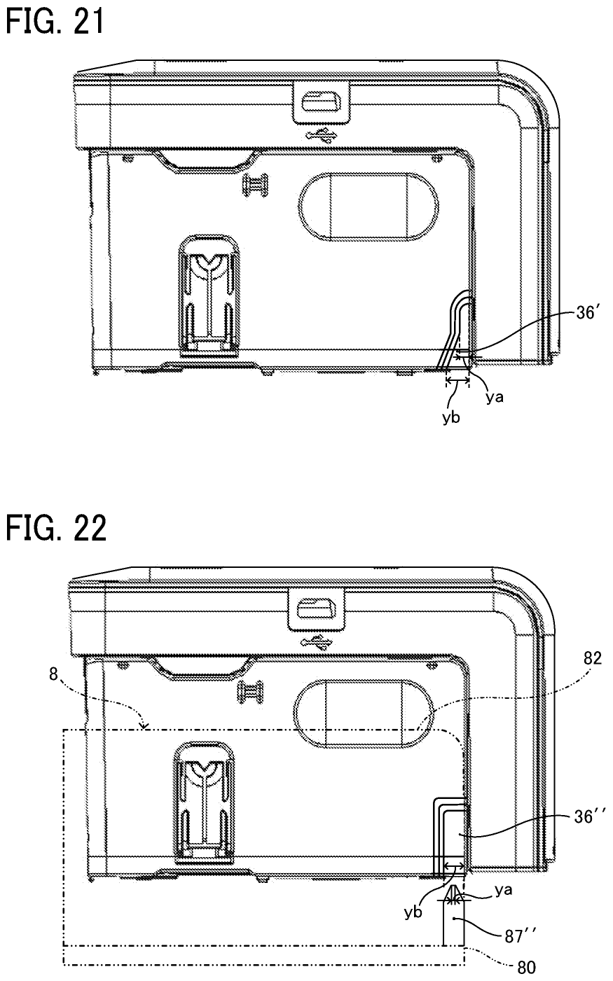

For example, as illustrated in FIG. 21, from the upstream side to the downstream side in the normal mounting direction (the direction in which the guide projection 87 enters a guide groove 36′ during the mounting movement), the groove width of the guide groove 36′ is narrowed until the groove width becomes substantially the same as the length of the guide projection 87 in the Y direction. In such a case, since the entrance width yb of the guide groove 36′ into which the guide projection 87 enters during the mounting movement is wider than the width ya of the leading end of the guide projection 87, the leading end of the guide projection 87 can enter the guide groove 36′ even if the Y-direction position of the guide projection 87 does not match and the Y direction of the guide groove 36′. Thus, user convenience is enhanced. Moreover, as the leading end of the guide projection 87 advances in the guide groove 36′, the width of the guide groove 36′ becomes narrower and finally becomes substantially the same as the width ya of the leading end of the guide projection 87. Therefore, when the mounting is completed, the leading end of the guide projection 87 is clamped by the downstream end portion of the guide groove 36′ in the mounting direction. The Y-direction position of the guide projection 87 matches the Y-direction position of the guide groove 36′, thus causing the Y-direction positions of the cover 8 to be positioned at the target position.

Alternatively, as illustrated in FIG. 22, from the downstream side to the upstream side in the normal mounting direction, the width of a guide projection 87″ may be increased until the width becomes substantially the same as the length of a guide groove 36″ in the Y direction. In such a case as well, since the entrance width yb of the guide groove 36″ is wider than the width ya of the leading end of the guide projection 87″, the leading end of the guide projection 87″ can enter the guide groove 36″ even if the Y-direction position of the guide projection 87″ does not match the Y-direction position of the guide groove 36″. Thus, user convenience is enhanced. Moreover, since the width of the rear end of the guide projection 87″ is substantially the same as the groove width yb of the guide groove 36″, the rear end of the guide projection 87″ is clamped by the guide groove 36″ when the mounting is completed. Accordingly, the Y-direction position of the guide projection 87″ matches the Y-direction position of the guide groove 36″, thus causing the Y-direction position to be positioned at the target position.

The second positioning member of the present embodiment is an example including the guide projection 87 on the cover 8 and the guide groove 36 on the printer body 1. However, the second positioning member is not limited to the example. For example, the second positioning member may include a guide groove on the cover 8 and a guide projection on the printer body 1.

Further, at least one of the guide projection 87 and the guide groove 36 may include a wear-resistant member. Such a configuration can restrain wear due to repeated attachment and detachment of the cover 8 to and from the printer body 1, thus enhancing the durability as a product. For example, the guide projection 87 may include a material (for example, polyacetal or the like) having a higher wear resistance than the base material of the cover 8. Alternatively, the guide projection 87 may include the same base material as the base material of the cover 8 and coated with a material having high wear resistance. The same applies to the guide groove 36.

In the present embodiment, the configuration has been described in which the recording portion 41 of the printer body 1 is the mounted portion and the cap portion 85 of the cover 8 to mount on the mounted portion is the mounting portion. However, the configuration of the mounted portion and the mounting portion is not limited to the above-described configuration. For example, a configuration may be employed in which the locked portions 45a and 45b of the spacer 4 as the detachable member of the printer body 1 are set as the mounted portions and the lock portions 86a and 86b of the cover 8 to mount on the locked portions 45a and 45b are set as the mounting portions.

In the present embodiment, the example of the inkjet-type printer 10 has been described. However, the configuration according to an embodiment of the present disclosure is also applicable to an apparatus using a different image forming method. The aspects of the present disclosure can be applied to a recording apparatus of, for example, thermal type or thermal-transfer type. A thermal transfer type printer body is provided with an ink ribbon serving as a storage container that stores a liquid. Thus, a recessed site may be formed at the bottom of the ink ribbon, and a position detection sensor serving as a detection device that detects a recording material may be accommodated in space included in the recessed site.

The above-described embodiments are limited examples, and the present disclosure includes, for example, the following aspects having advantageous effects.

Aspect 1

For Aspect 1, an image forming apparatus (for example, the handheld printer 10) includes an apparatus body (for example, the printer body 1), a cover (for example, the cover 8), a first positioning member (for example, the left wall 82 and the right wall 83), and a second positioning member (for example, the guide groove 36 and the guide projection 87). The apparatus body includes a mounted portion (for example, the recording portion 41). The cover is detachably mounted on the apparatus body and includes a mounting portion (for example, the cap portion 85) to be mounted on the mounted portion of the apparatus body. The first positioning member positions the cover at a first target position in a first direction (for example, the X direction) with respect to the apparatus body. The second positioning member positions the cover at a second target position in a second direction (for example, the Y direction) orthogonal to the first direction with respect to the apparatus body, before the mounting portion is mounted on the mounted portion after the cover is positioned at the first target position by the first positioning member. In order for the cover to be correctly mounted on the apparatus body such that the mounting portion of the cover is mounted on the mounted portion of the apparatus body, the cover needs to be mounted from the normal mounting direction while being positioned at the respective target positions (the first target position and the second target position) with respect to two directions (the first direction and the second direction orthogonal to the first direction). In the present aspect, firstly, the cover is positioned to the first target position by the first positioning member in the first direction, and then is positioned to the second target position by the second positioning member in the second direction. As described above, performing the positioning in the first direction and the positioning in the second direction in a stepwise manner allows the user operation to be more easily performed than in the case in which the positioning in both directions are simultaneously performed. As a result, an improper user operation such that the cover is not correctly mounted on the target position on the apparatus body can be prevented, and the cover can be correctly mounted on the apparatus body without the mounted portion colliding with the mounting portion or the like.

Aspect 2

For Aspect 2, in Aspect 1, the second positioning member contacts the apparatus body or the cover, when the cover is not positioned at the second target position, to restrict movement of the mounting portion in an approach direction in which the mounting portion approaches the mounted portion. According to the present aspect, even when the cover is moved for mounting without being located at the second target position, it is possible to prevent the mounted portion from colliding with the mounting portion or the like, thus reducing damage or break of the mounted portion or the mounting portion.

Aspect 3

For Aspect 3, in Aspect 2, the cover includes a cover base (for example, the bottom board 80) with the mounting portion and a cover one-side wall (for example, the rear wall 84) extending from the cover base. The cover one-side wall contacts one side of the apparatus body in the second direction to restrict movement of the cover in a contact direction in which the cover moves to contact the apparatus body. The second positioning member is disposed on a side wall of the cover in the first direction and at a position deviated to an opposite side of the cover one-side wall in the second direction. In a case in which the second positioning member is disposed at a position deviated to the cover one-side wall, when the mounting movement is performed in a state in which the apparatus body is slightly shifted to the opposite side to the cover one-side wall with respect to the cover, the second positioning member cannot restrict the movement of the cover in the mounting direction. The mounted portion of the apparatus body, the mounting portion of the cover, and the like come into contact with the counterparts and are likely to be damaged or broken. With the arrangement of the present aspect, such a failure can be restrained.

Aspect 4

For Aspect 4, in Aspect 2 or 3, the cover includes a rotation stopper (for example, the projection 16) to restrict the apparatus body and the cover from relatively rotating around a contact point of the second positioning member against the apparatus body or the cover, when the second positioning member restricts the movement of the mounting portion in the approach direction. According to the present aspect, even when the relative rotation occurs around the contact point where the second positioning member comes into contact for the movement restriction in the mounting direction, the above-described configuration can prevent the mounted portion of the apparatus body, the mounting portion of the cover, and the like from contacting the counterparts and being damaged or broken.

Aspect 5

For Aspect 5, in Aspect 4, the first positioning member includes a plurality of cover side walls (for example, the left wall 82 and the right wall 83) extending from the cover base. The plurality of cover side walls contacts both sides of the apparatus body in the first direction to position the cover at the first target position. The apparatus body includes a plurality of projections (for example, the projections 16) on both sides of the apparatus body in the first direction. Each of the plurality of projections contacts an end portion (for example, the upper end) of each of the plurality of cover side walls to restrict the apparatus body and the cover from relatively rotating around the contact point. The end portion is at an opposite side of the cover base in each of the plurality of cover side walls. Such a configuration can restrict the relative rotation with a simple configuration.

Aspect 6

For Aspect 6, in Aspect 5, each of the plurality of projections (for example, the projections 16) is a holding portion to hold a held portion (for example, the concave portion 81) of each of the plurality of cover side walls when the cover is mounted to the apparatus body. According to the present aspect, since the holding portion is used as the rotation stopper, the configuration can be simplified.

Aspect 7

For Aspect 7, in any one of Aspects 1 to 6, the second positioning member includes a guide projection (for example, the guide projection 87) on the cover and a guide groove (for example, the guide groove 36 or the guide groove 36″) on the apparatus body to guide the guide projection along a normal mounting direction of the mounting portion to the mounted portion while restricting movement of the guide projection in the second direction. Such a configuration allows the cover to be correctly mounted to the target position of the apparatus body in the state in which the cover is positioned in the first direction and in the second direction with respect to the apparatus body.

Aspect 8

For Aspect 8, in Aspect 7, a length in the second direction of an entrance of the guide groove into which a leading end of the guide projection enters when the cover is mounted to the apparatus body is greater than a length in the second direction of the leading end of the guide projection. A length in the second direction of a portion of the guide projection that has entered the guide groove when mounting of the cover to the apparatus body is complete is substantially same as a length in the second direction of a portion of the guide groove facing the portion of the guide projection. Such a configuration allows the guide projection to be easily inserted into the guide groove by a user operation, thus enhancing the convenience for the user.

Aspect 9

For Aspect 9, in Aspect 7 or 8, at least one of the guide projection and the guide groove includes a wear-resistant member. Such a configuration can restrain abrasion due to repeated attachment and detachment of the cover to and from the apparatus body, thus enhancing the durability as a product.

Aspect 10

For Aspect 10, in any one of Aspects 1 to 9, the mounted portion includes an image forming device (for example, the recording portion 41). Such a configuration allows the cover to be correctly mounted on the apparatus body without the image forming device colliding with the mounting portion or the like.

Aspect 11

For Aspect 11, in any one of Aspects 1 to 10, the image forming apparatus includes an attachment (for example, the spacer 4) detachably attached on the apparatus body. The cover is mounted on the apparatus body in a state in which the cover covers the attachment attached on the apparatus body. The mounting portion of the cover is an engaging portion (for example, the lock portions 86a and 86b) and the mounted portion of the apparatus body is an engaged portion (for example, the locked portions 45a and 45b). The image forming apparatus further includes a switching device (for example, the slide lock member 86) to switch a holding state in which the attachment is held by the cover and a non-holding state in which the attachment is not held by the cover. The switching device engages the engaging portion with the engaged portion being housed in the cover, to turn the attachment into the holding state. The switching device disengages the engaging portion from the engaged portion, to turn the attachment into the non-holding state. Such a configuration allows the cover to be correctly mounted on the apparatus body without the engaging portion or the engaged portion colliding with the counterpart.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An image forming apparatus comprising:
an apparatus body including a mounted portion;
a cover detachably mounted on the apparatus body, the cover including a mounting portion configured to be mounted on the mounted portion of the apparatus body;
a first positioning member configured to position the cover at a first target position in a first direction with respect to the apparatus body; and
a second positioning member configured to position the cover at a second target position in a second direction orthogonal to the first direction with respect to the apparatus body, before the mounting portion is mounted on the mounted portion after the cover is positioned at the first target position by the first positioning member.

2. The image forming apparatus according to claim 1,
wherein the second positioning member is configured to contact the apparatus body or the cover, when the cover is not positioned at the second target position, to restrict movement of the mounting portion in an approach direction in which the mounting portion approaches the mounted portion.

3. The image forming apparatus according to claim 2,
wherein the cover including:
a cover base on which the mounting portion is disposed; and
a cover one-side wall extending from the cover base and being configured to contact one side of the apparatus body in the second direction to restrict movement of the cover in a contact direction in which the cover moves to contact the apparatus body,
wherein the second positioning member is disposed on a side wall of the cover in the first direction and at a position deviated to an opposite side of the cover one-side wall in the second direction.

4. The image forming apparatus according to claim 2,
wherein the cover includes a rotation stopper configured to restrict the apparatus body and the cover from relatively rotating around a contact point of the second positioning member against the apparatus body or the cover, when the second positioning member restricts the movement of the mounting portion in the approach direction.

5. The image forming apparatus according to claim 4,
wherein the cover includes a cover base on which the mounting portion is disposed,
wherein the first positioning member includes a plurality of cover side walls extending from the cover base, the plurality of cover side walls configured to contact both sides of the apparatus body in the first direction to position the cover at the first target position,
wherein the apparatus body includes a plurality of projections on both sides of the apparatus body in the first direction, each of the plurality of projections configured to contact an end portion of each of the plurality of cover side walls to restrict the apparatus body and the cover from relatively rotating around the contact point,
wherein the end portion is at an opposite side of the cover base in each of the plurality of cover side walls.

6. The image forming apparatus according to claim 5,
wherein each of the plurality of projections is a holding portion configured to hold a held portion of each of the plurality of cover side walls when the cover is mounted to the apparatus body.

7. The image forming apparatus according to claim 1,
wherein the second positioning member includes:
a guide projection on the cover; and
a guide groove on the apparatus body configured to guide the guide projection along a normal mounting direction of the mounting portion to the mounted portion while restricting movement of the guide projection in the second direction.

8. The image forming apparatus according to claim 7,
wherein a length in the second direction of an entrance of the guide groove into which a leading end of the guide projection enters when the cover is mounted to the apparatus body is greater than a length in the second direction of the leading end of the guide projection,
wherein a length in the second direction of a portion of the guide projection that has entered the guide groove when mounting of the cover to the apparatus body is complete is substantially same as a length in the second direction of a portion of the guide groove facing the portion of the guide projection.

9. The image forming apparatus according to claim 7,
wherein at least one of the guide projection and the guide groove includes a wear-resistant member.

10. The image forming apparatus according to claim 1,
wherein the mounted portion includes an image forming device.

11. The image forming apparatus according to claim 1, further comprising an attachment detachably attached on the apparatus body,
wherein the cover is mounted on the apparatus body in a state in which the cover covers the attachment attached on the apparatus body,
wherein the mounting portion of the cover is an engaging portion and the mounted portion of the apparatus body is an engaged portion,
wherein the image forming apparatus further comprises a switching device configured to switch a holding state in which the attachment is held by the cover and a non-holding state in which the attachment is not held by the cover,
wherein the switching device is configured to engage the engaging portion with the engaged portion being housed in the cover, to turn the attachment into the holding state,
wherein the switching device is configured to disengage the engaging portion from the engaged portion, to turn the attachment into the non-holding state.
